(19) United States
(12) Patent Application Publication
(10) Pub. No.: US 2026/0200748 A1
(43) Pub. Date: Jul. 16, 2026

(54) METHOD FOR RECYCLING LITHIUM SECONDARY BATTERY COMPRISING SULFIDE-BASED SOLID ELECTROLYTE THROUGH WATER IMMERSION

(71) Applicant: SUNGEEL HITECH CO. LTD, Gunsan-si (KR)

(72) Inventors: Ji-Yeon BAEK, Gunsan-si (KR); Jin-Uk LEE, Gunsan-si (KR); Ah-Reum LEE, Gunsan-si (KR); Won-Hwa HEO, Gunsan-si (KR)

(21) Appl. No.: 19/319,305

(22) Filed: Sep. 4, 2025

(30) Foreign Application Priority Data
Jan. 14, 2025 (KR) 10-2025-0005640

(51) Int. Cl. C01D 15/06; C01B 17/22; C01B 25/30; C01D 15/02; C01D 15/04; H01M 10/54

(52) U.S. Cl. CPC C01D 15/06; C01B 17/22; C01B 25/30; C01D 15/02; C01D 15/04; H01M 10/54

(57) ABSTRACT

The present disclosure provides a method for recycling a lithium secondary battery comprising a sulfide-based solid electrolyte through water immersion, in which the atmospheric instability of the sulfide-based solid electrolyte of a waste battery and the risk of exposure to hydrogen sulfide (H₂S) gas are blocked by subjecting the sulfide-based solid electrolyte to water immersion.

### CROSS-REFERENCE TO RELATED APPLICATION

This application claims priority to Korean Patent Application No. 10-2025-0005640 filed on Jan. 14, 2025, and all the benefits accruing therefrom under 35 U.S.C. § 119, the contents of which are incorporated herein by reference in their entirety.

### BACKGROUND OF THE DISCLOSURE

### Field of the Disclosure

The present disclosure relates to a method for recycling a lithium secondary battery comprising a sulfide-based solid electrolyte through water immersion, wherein the atmospheric instability of the sulfide-based solid electrolyte and the risk of exposure to hydrogen sulfide (H₂S) gas are blocked by immersing the sulfide-based solid electrolyte in water.

### Description of the Related Art

Recycling of lithium secondary batteries refers to the recovery and reutilization of valuable metals such as Co, Ni, Mn, and Li contained therein. The recycling process of lithium secondary batteries involves a pretreatment step including crushing and separation to obtain a black powder containing valuable metals, followed by hydrometallurgical processes such as leaching, solvent extraction, and crystallization to recover the valuable metals.

Valuable metals are contained in lithium secondary batteries in higher amounts compared with natural ores, and their deposits are concentrated in specific countries. Therefore, recycling is important for securing and stabilizing the domestic supply of these critical raw materials.

A lithium secondary battery is composed of a cathode, an anode, an electrolyte, and a separator. The electrolyte transports lithium ions between the cathode and the anode, while the separator prevents direct contact between them. The difference between a commercialized lithium secondary battery and an all-solid-state battery lies in the electrolyte: commercialized lithium secondary batteries employ liquid electrolytes, whereas all-solid-state batteries employ solid electrolytes.

The electrolyte functions as a medium for the migration of lithium ions between the cathode and the anode during charging and discharging. Liquid electrolytes are mainly composed of organic solvents (such as EC, PC, DMC, EMC, etc.), which are flammable and thus prone to fire or explosion under temperature variation or external impact.

In contrast, solid electrolytes, being in a solid state, eliminate the risk of leakage, exhibit lower sensitivity to temperature compared with liquid electrolytes, and thereby provide the advantage of improving the stability of batteries.

However, solid electrolytes generally exhibit lower lithium-ion mobility during charging and discharging compared with liquid electrolytes. Therefore, they are mixed with cathode and anode active materials and coated on electrodes to facilitate smooth lithium-ion migration.

Among solid electrolytes, sulfide-based solid electrolytes are regarded as highly promising due to their superior ionic conductivity.

Nevertheless, sulfide-based solid electrolytes suffer from atmospheric instability and hygroscopicity. When exposed to the atmosphere, they react with H₂O to generate hydrogen sulfide (H₂S), a harmful gas, and result in liquid formation on the surface, accompanied by decomposition into compounds such as Li₂SO₄, LiCl, Li₃PO₄, LiOH, and Li₂S.

Accordingly, when conventional lithium-ion battery recycling technologies are applied to all-solid-state batteries containing sulfide-based solid electrolytes, hydrogen sulfide gas (H₂S) is generated during crushing and acid dissolution processes.

Therefore, it is necessary to remove such atmospheric instability and hygroscopicity during the initial pretreatment stage in order to enable smooth recycling of lithium secondary batteries containing sulfide-based solid electrolytes.

Accordingly, after extensive efforts and numerous studies, the applicant has completed the present disclosure by establishing a method for recycling a lithium secondary battery comprising a sulfide-based solid electrolyte through water immersion, thereby preventing the occurrence of the aforementioned problems and enabling a stable recycling process.

### Related Patent Document

Korean Registered Patent No. 10-1930992 (Registered on Dec. 13, 2018)

### SUMMARY OF THE DISCLOSURE

Therefore, the purpose of the present disclosure is to provide a method for recycling a lithium secondary battery comprising a sulfide-based solid electrolyte through water immersion, wherein the atmospheric instability of the sulfide-based solid electrolyte and the risk of exposure to hydrogen sulfide (H₂S) gas are blocked by immersing the sulfide-based solid electrolyte in water.

The challenges that the present dislosure is intended to solve are not limited to those mentioned above, and other challenges not mentioned will be apparent to those skilled in the art from the following description.

In order to achieve the purpose, an aspect of the present disclosure provides a method for recycling a lithium secondary battery comprising a sulfide-based solid electrolyte through water immersion, the method comprising:
subjecting the sulfide-based solid electrolyte of a waste battery comprising a sulfide-based solid electrolyte to water immersion to suppress generation of hydrogen sulfide (H₂S) gas; and
converting the sulfide-based solid electrolyte into a lithium compound.

In some exemplary embodiments, the sulfide-based solid electrolyte may be subjected to water immersion after being separated from the waste battery, or may be subjected to water immersion in a state of being not separated from the waste battery.

In some exemplary embodiments, the sulfide-based solid electrolyte may comprise at least one selected from the group consisting of Li₁₀GeP₂S₁₂(LGPS), Li₇P₃Sn₁₁(LPS), Li_{9.54}Si_{1.74}P_{1.44}S_{11.7}Cl_{0.3}(LPSCl), and Li₆PS₅X(X=Cl, Br, or I)(Argyrodite).

In some exemplary embodiments, the water immersion may be performed at a temperature ranging from 10° C. to 100° C., for a time period ranging from 2 minutes to 6 hours.

In addition, air or nitrogen gas may be introduced during the water immersion.

In some exemplary embodiments, the air or nitrogen gas may be introduced during the water immersion at a flow rate ranging from 0.5 to 50 L/min.

In some exemplary embodiments, when the sulfide-based solid electrolyte is subjected to water immersion, in a case where a content ratio of the sulfide-based solid electrolyte to water is in a weight ratio ranging from 1:3 to 1:100,
an amount of hydrogen sulfide (H₂S) gas generation measured by a hydrogen sulfide (H₂S) gas detector may range from 0 to 250 ppm, and
after the hydrogen sulfide (H₂S) gas has generated, a time required for the amount of hydrogen sulfide (H₂S) gas generation to return to 0 ppm may range from 2 minutes to 1 hour.

In some exemplary embodiments, the lithium compound may be at least one selected from the group consisting of Li₂SO₄, LiCl, Li₃PO₄, LiOH, and Li₂S.

In some exemplary embodiments, after being subjected to water immersion, the lithium secondary battery comprising a sulfide-based solid electrolyte may be stable against atmospheric moisture.

In some exemplary embodiments, after being subjected to water immersion, the lithium secondary battery comprising a sulfide-based solid electrolyte may be stable against water.

In some exemplary embodiments, after being subjected to water immersion, the lithium secondary battery comprising a sulfide-based solid electrolyte is stable against an inorganic acid selected from the group consisting of hydrochloric acid (HCl), nitric acid (HNO₃), and sulfuric acid (H₂SO₄).

According to an exemplary embodiment of the present disclosure, there is provided a method for recycling a lithium secondary battery comprising a sulfide-based solid electrolyte through water immersion, in which the atmospheric instability of the sulfide-based solid electrolyte of a waste battery and the risk of exposure to hydrogen sulfide (H₂S) gas are blocked by subjecting the sulfide-based solid electrolyte to water immersion.

Accordingly, the lithium secondary battery comprising the recycled sulfide-based solid electrolyte is stable against atmospheric moisture, stable against water, and stable against inorganic acid.

The effects of the present disclosure are not limited to the above effects, but are to be understood to include all effects that can be inferred from the detailed description of the present disclosure or from the composition of the elements as recited in the claims.

### BRIEF DESCRIPTION OF THE DRAWINGS

FIG. 1 is a graph comparing the time required for the concentration of hydrogen sulfide (H₂S) generated by immersing the sulfide-based solid electrolyte in water at different ratios, according to an exemplary embodiment of the present disclosure, to return to 0 ppm in a method for recycling a lithium secondary battery comprising a sulfide-based solid electrolyte through water immersion.

FIG. 2 is a graph comparing the concentration of hydrogen sulfide (H₂S) generated according to water immersion and atmospheric exposure of a sulfide-based solid electrolyte in a method for recycling a lithium secondary battery comprising a sulfide-based solid electrolyte through water immersion, according to an exemplary embodiment of the present disclosure.

### DETAILED DESCRIPTION OF THE DISCLOSURE

Hereinafter, exemplary embodiments of the present disclosure will be described in detail with reference to related drawings.

The advantages and features of the present disclosure, and methods of accomplishing those advantages and features, will become apparent upon reference to the exemplary embodiments described in detail with reference to the accompanying drawings.

However, the present disclosure is not limited by the exemplary embodiments disclosed herein, but will be embodied in many and various forms. Therefore, those exemplary embodiments are provided merely to make the present disclosure complete and to give a complete picture of the scope of the present disclosure to one of ordinary skill in the art to which the present disclosure belongs, and the present disclosure shall be defined by the scope of the claims.

Further, hereinafter, in describing the present disclosure, a detailed description of a configuration determined that may unnecessarily obscure the subject matter of the present disclosure, for example, a detailed description of a known technology including the prior art may be omitted.

As used herein, the terms “generation” and “concentration” refer to “the amount (concentration) of hydrogen sulfide (H₂S) gas,” which denotes the quantity of hydrogen sulfide (H₂S) gas and is measured in terms of its concentration in ppm.

Hereinafter, exemplary embodiments of the present disclosure will be described in detail.

### Method for Recycling a Lithium Secondary Battery Comprising a Sulfide-Based Solid Electrolyte Through Water Immersion

The present disclosure provides a method for recycling a lithium secondary battery comprising a sulfide-based solid electrolyte through water immersion, in which the atmospheric instability of the sulfide-based solid electrolyte of a waste battery and the risk of exposure to hydrogen sulfide (H₂S) gas are blocked by subjecting the sulfide-based solid electrolyte to water immersion.

The method for recycling a lithium secondary battery comprising a sulfide-based solid electrolyte through water immersion according to the present disclosure comprises: subjecting the sulfide-based solid electrolyte of a waste battery comprising a sulfide-based solid electrolyte to water immersion to suppress generation of hydrogen sulfide (H₂S) gas; and converting the sulfide-based solid electrolyte into a lithium compound.

Since the present disclosure provides a method for recycling a lithium secondary battery comprising a sulfide-based solid electrolyte through water immersion, in which the atmospheric instability of the sulfide-based solid electrolyte of a waste battery and the risk of exposure to hydrogen sulfide (H₂S) gas are blocked by subjecting the sulfide-based solid electrolyte to water immersion, the lithium secondary battery comprising the recycled sulfide-based solid electrolyte according to the method is stable against atmospheric moisture, stable against water, and stable against inorganic acid.

Recycling of lithium secondary batteries refers to the recovery and reutilization of valuable metals such as Co, Ni, Mn, and Li contained therein. The recycling process of lithium secondary batteries involves a pretreatment step including crushing and separation to obtain a black powder containing valuable metals, followed by hydrometallurgical processes such as leaching, solvent extraction, and crystallization to recover the valuable metals.

Valuable metals are contained in lithium secondary batteries in higher amounts compared with natural ores, and their deposits are concentrated in specific countries. Therefore, recycling is important for securing and stabilizing the domestic supply of these critical raw materials.

A lithium secondary battery is composed of a cathode, an anode, an electrolyte, and a separator. The electrolyte transports lithium ions between the cathode and the anode, while the separator prevents direct contact between them. The difference between a commercialized lithium secondary battery and an all-solid-state battery lies in the electrolyte: commercialized lithium secondary batteries employ liquid electrolytes, whereas all-solid-state batteries employ solid electrolytes.

The electrolyte functions as a medium for the migration of lithium ions between the cathode and the anode during charging and discharging. Liquid electrolytes are mainly composed of organic solvents (such as EC, PC, DMC, EMC, etc.), which are flammable and thus prone to fire or explosion under temperature variation or external impact.

In contrast, solid electrolytes, being in a solid state, eliminate the risk of leakage, exhibit lower sensitivity to temperature compared with liquid electrolytes, and thereby provide the advantage of improving the stability of batteries.

However, solid electrolytes generally exhibit lower lithium-ion mobility during charging and discharging compared with liquid electrolytes. Therefore, they are mixed with cathode and anode active materials and coated on electrodes to facilitate smooth lithium-ion migration.

Among solid electrolytes, sulfide-based solid electrolytes are regarded as highly promising due to their superior ionic conductivity.

Nevertheless, sulfide-based solid electrolytes suffer from atmospheric instability and hygroscopicity. When exposed to the atmosphere, they react with H₂O to generate hydrogen sulfide (H₂S), a harmful gas, and result in liquid formation on the surface, accompanied by decomposition into compounds such as Li₂SO₄, LiCl, Li₃PO₄, LiOH, and Li₂S.

Accordingly, when conventional lithium-ion battery recycling technologies are applied to all-solid-state batteries containing sulfide-based solid electrolytes, hydrogen sulfide gas (H₂S) is generated during crushing and acid dissolution processes.

Therefore, it is necessary to remove such atmospheric instability and hygroscopicity during the initial pretreatment stage in order to enable smooth recycling of lithium secondary batteries containing sulfide-based solid electrolytes.

Accordingly, after extensive efforts and numerous studies, the applicant has completed the present disclosure by establishing a method for recycling a lithium secondary battery comprising a sulfide-based solid electrolyte through water immersion, thereby preventing the occurrence of the aforementioned problems and enabling a stable recycling process.

The present disclosure may be a method for recycling a lithium secondary battery comprising a sulfide-based solid electrolyte through water immersion, wherein the atmospheric instability of the sulfide-based solid electrolyte and the risk of exposure to hydrogen sulfide (H₂S) gas are blocked by immersing the sulfide-based solid electrolyte in water.

That is, the present disclosure provides a method for recycling a lithium secondary battery comprising a sulfide-based solid electrolyte through water immersion, in which the atmospheric instability of the sulfide-based solid electrolyte of a waste battery and the risk of exposure to hydrogen sulfide (H₂S) gas are blocked by subjecting the sulfide-based solid electrolyte to water immersion. Accordingly, the lithium secondary battery comprising the recycled sulfide-based solid electrolyte may be stable against atmospheric moisture, stable against water, and stable against inorganic acid.

In addition, the method for recycling a lithium secondary battery comprising a sulfide-based solid electrolyte through water immersion may comprise: subjecting the sulfide-based solid electrolyte of a waste battery comprising a sulfide-based solid electrolyte to water immersion to suppress generation of hydrogen sulfide (H₂S) gas; and converting the sulfide-based solid electrolyte into a lithium compound.

Further, the sulfide-based solid electrolyte may be subjected to water immersion after being separated from the waste battery, or may be subjected to water immersion in a state of being not separated from the waste battery.

Here, the sulfide-based solid electrolyte may comprise at least one selected from the group consisting of Li₁₀GeP₂S₁₂(LGPS), Li₇P₃Sn₁₁(LPS), Li_{9.54}Si_{1.74}P_{1.44}S_{11.7}Cl_{0.3}(LPSCl), and Li₆PS₅X(X=Cl, Br, or I)(Argyrodite).

Further, the water immersion may be performed at a temperature ranging from 10° C. to 100° C., for a time period ranging from 2 minutes to 6 hours.

In addition, air or nitrogen gas may be introduced during the water immersion.

Here, when the water immersion temperature is within the above range, the sulfide-based solid electrolyte can be converted into a lithium compound that is stable in the atmosphere.

In this case, the water immersion temperature may preferably range from 10 to 90° C., more preferably from 15 to 85° C., and still more preferably from 20 to 80° C.

In addition, when the water immersion time is within the above range, the sulfide-based solid electrolyte can be converted into a lithium compound that is stable in the atmosphere.

In this case, the water immersion time may preferably range from 5 minutes to 6 hours, more preferably from 5 minutes to 5 hours, and still more preferably from 10 minutes to 4 hours.

In addition, the air or nitrogen gas may be introduced during the water immersion at a flow rate ranging from 0.5 to 50 L/min.

Here, when the injection flow rate is within the above range, the sulfide-based solid electrolyte can be converted into a lithium compound that is stable in the atmosphere.

In this case, the injection flow rate may preferably range from 0.5 to 45 L/min, more preferably from 1 to 40 L/min, and still more preferably from 2 to 35 L/min.

In addition, when the sulfide-based solid electrolyte is subjected to water immersion, in a case where a content ratio of the sulfide-based solid electrolyte to water is in a weight ratio ranging from 1:3 to 1:100,
an amount of hydrogen sulfide (H₂S) gas generation measured by a hydrogen sulfide (H₂S) gas detector may range from 0 to 250 ppm, and
after the hydrogen sulfide (H₂S) gas has generated, a time required for the amount of hydrogen sulfide (H₂S) gas generation to return to 0 ppm may range from 2 minutes to 1 hour.

Further, the lithium compound may be at least one selected from the group consisting of Li₂SO₄, LiCl, Li₃PO₄, LiOH, and Li₂S.

In addition, after being subjected to water immersion, the lithium secondary battery comprising a sulfide-based solid electrolyte may be stable against atmospheric moisture.

Moreover, after being subjected to water immersion, the lithium secondary battery comprising a sulfide-based solid electrolyte may be stable against water.

Further, after being subjected to water immersion, the lithium secondary battery comprising a sulfide-based solid electrolyte is stable against an inorganic acid selected from the group consisting of hydrochloric acid (HCl), nitric acid (HNO₃), and sulfuric acid (H₂SO₄).

For example, by subjecting the sulfide-based solid electrolyte of a waste battery comprising Argyrodite(Li₆PS₅Cl), which is a sulfide-based solid electrolyte, to water immersion, generation of hydrogen sulfide (H₂S) gas can be suppressed, and the sulfide-based solid electrolyte can be converted into a lithium compound.

Here, the lithium compound may be at least one selected from the group consisting of Li₂SO₄, LiCl, Li₃PO₄, LiOH, and Li₂S.

Thereafter, in order to confirm the atmospheric stability of the sulfide-based solid electrolyte subjected to water immersion, the sulfide-based solid electrolyte after water immersion was immersed in water according to weight ratios of the sulfide-based solid electrolyte to water, and the concentration of hydrogen sulfide gas generated was measured in ppm using a hydrogen sulfide gas detector.

Here, the method of measuring the concentration of hydrogen sulfide gas was performed by adding the sulfide-based solid electrolyte and water into a container containing the sulfide-based solid electrolyte, connecting a hydrogen sulfide gas detector to the inlet of the container, and measuring the amount of gas generated and the time.

By this method, the time required for the concentration of hydrogen sulfide gas to return to 0 ppm was measured.

As a result, it was confirmed that, when the sulfide-based solid electrolyte was subjected to water immersion, the greater the content of water in the weight ratio of the sulfide-based solid electrolyte to water, the lower the concentration of hydrogen sulfide (H₂S) gas generated when the water-immersed sulfide-based solid electrolyte was immersed in water.

Here, the conditions for water immersion of the sulfide-based solid electrolyte were such that the water immersion was carried out under an air or N₂ atmosphere, with an immersion time of 2 minutes to 6 hours and an immersion temperature of 10° C. to 100° C.

It was confirmed that, when the sulfide-based solid electrolyte was subjected to water immersion, the greater the content of water in the weight ratio of the sulfide-based solid electrolyte to water, the lower the concentration of hydrogen sulfide (H₂S) gas generated when the water-immersed sulfide-based solid electrolyte was immersed in water.

Through this, it was verified that, by the pretreatment method through water immersion, the sulfide-based solid electrolyte can be converted into a compound that is stable against moisture in the atmosphere.

That is, the pretreatment of the sulfide-based solid electrolyte was carried out through water immersion under an air or N₂ atmosphere, with an immersion time of 2 minutes to 6 hours and an immersion temperature of 10° C. to 100° C., and as a result, it was confirmed that, after water immersion, the compounds identified showed a decrease in sulfur (S) content as expected and were decomposed into compounds stable in the atmosphere.

In addition, in order to confirm the atmospheric stability of the sulfide-based solid electrolyte subjected to water immersion, the water-immersed sulfide-based solid electrolyte was immersed in water under the same conditions, and its atmospheric stability was verified using a hydrogen sulfide (H₂S) gas detector.

For comparison, the sulfide-based solid electrolyte that was not subjected to water immersion was also tested for hydrogen sulfide gas (H₂S) concentration by the same method.

In this case, the sulfide-based solid electrolyte that was not subjected to water immersion exhibited a maximum hydrogen sulfide gas concentration of 250 ppm when immersed in water for 2 minutes, indicating excessive hydrogen sulfide generation, and the time required for the hydrogen sulfide gas concentration to return to 0 ppm was as long as 1800 seconds (30 minutes), thereby failing to stabilize in the atmosphere.

In the following, exemplary embodiments of the present disclosure will be described in more detail. However, the following exemplary embodiments are intended to further illustrate the present disclosure, and the scope of the present disclosure is not limited by the following exemplary embodiments. The following exemplary embodiments may be modified and altered as appropriate by those skilled in the art within the scope of the present disclosure.

### EXEMPLARY EMBODIMENTS

### <Exemplary Embodiments 1 to 8> Method for Recycling a Lithium Secondary Battery Comprising a Sulfide-Based Solid Electrolyte Through Water Immersion, in which Hydrogen Sulfide Converges to 0 ppm after a Certain Period of Time

First, a sulfide-based solid electrolyte was obtained from a waste battery comprising Argyrodite(Li₆PS₅Cl), and placed in a desiccator connected to a hydrogen sulfide (H₂S) gas detector, while air was introduced at a flow rate of 5 L/min. The sulfide-based solid electrolyte was subjected to water immersion at 20° C. for 2 hours at weight ratios of sulfide-based solid electrolyte to water as shown in Table 1 below, and the concentration of hydrogen sulfide gas was measured in ppm using the hydrogen sulfide gas detector.

Through the water immersion, generation of hydrogen sulfide (H₂S) gas was suppressed, and the sulfide-based solid electrolyte was converted into a lithium compound.

The lithium compound was Li₂SO₄, LiCl, Li₃PO₄, LiOH, or Li₂S.

Thereafter, by the method of measuring the concentration of hydrogen sulfide gas, the time required for the concentration of hydrogen sulfide gas to reach 0 ppm was determined.

In addition, the sulfide-based solid electrolyte treated by the pretreatment method through water immersion was exposed to atmospheric moisture, immersed in water, or immersed in hydrochloric acid, and, in each case, the time required for the concentration of hydrogen sulfide gas to reach 0 ppm was measured by the hydrogen sulfide gas measurement method, thereby evaluating the stability.

In addition, the sulfide-based solid electrolyte treated by the pretreatment method through water immersion was immersed in water, and the time required for the concentration of hydrogen sulfide gas to reach 0 ppm was measured by the hydrogen sulfide gas measurement method to evaluate stability.

Furthermore, the sulfide-based solid electrolyte treated by the pretreatment method through water immersion was immersed in hydrochloric acid, and the time required for the concentration of hydrogen sulfide gas to reach 0 ppm was measured by the hydrogen sulfide gas measurement method to evaluate stability.

### Comparative Embodiments 1 to 2: Method for Recycling a Lithium Secondary Battery Comprising a Sulfide-Based Solid Electrolyte Through Water Immersion, in which Hydrogen Sulfide does not Converge to 0 ppm

Except that the sulfide-based solid electrolyte was subjected to water immersion at weight ratios of sulfide-based solid electrolyte to water as shown in Table 1, the concentration of hydrogen sulfide gas and the time required for the concentration of hydrogen sulfide gas to reach 0 ppm were measured in the same manner as in Exemplary Embodiment 1.

In addition, the lithium secondary battery comprising the sulfide-based solid electrolyte subjected to water immersion was exposed to atmospheric moisture, and the time required for the concentration of hydrogen sulfide gas to reach 0 ppm was measured by the hydrogen sulfide gas measurement method to evaluate stability.

Furthermore, the lithium secondary battery comprising the sulfide-based solid electrolyte subjected to water immersion was immersed in water, and the time required for the concentration of hydrogen sulfide gas to reach 0 ppm was measured by the hydrogen sulfide gas measurement method to evaluate stability.

In addition, the lithium secondary battery comprising the sulfide-based solid electrolyte subjected to water immersion was immersed in hydrochloric acid, and the time required for the concentration of hydrogen sulfide gas to reach 0 ppm was measured by the hydrogen sulfide gas measurement method to evaluate stability.

TABLE 1

| | Exemplary | Exemplary | Exemplary | Exemplary | Exemplary | Exemplary | Exemplary | Exemplary | Comparative | Comparative |
|---|---|---|---|---|---|---|---|---|---|---|
| | Embodi- | Embodi- | Embodi- | Embodi- | Embodi- | Embodi- | Embodi- | Embodi- | Embodi- | Embodi- |
| | ment 1 | ment 2 | ment 3 | ment 4 | ment 5 | ment 6 | ment 7 | ment 8 | ment 1 | ment 2 |
| Type of | Argyrodite | Argyrodite | Argyrodite | Argyrodite | Argyrodite | Argyrodite | Argyrodite | Argyrodite | Argyrodite | Argyrodite |
| sulfide- | (Li₆PS₅Cl) | (Li₆PS₅Cl) | (Li₆PS₅Cl) | (Li₆PS₅Cl) | (Li₆PS₅Cl) | (Li₆PS₅Cl) | (Li₆PS₅Cl) | (Li₆PS₅Cl) | (Li₆PS₅Cl) | (Li₆PS₅Cl) |
| based solid | | | | | | | | | | |
| electrolyte | | | | | | | | | | |
| Weight | 1:3 | 1:4 | 1:5 | 1:10 | 1:15 | 1:20 | 1:40 | 1:100 | 1:1 | 1:2 |
| ratio of | | | | | | | | | | |
| sulfide- | | | | | | | | | | |
| based solid | | | | | | | | | | |
| electro- | | | | | | | | | | |
| lyte:water | | | | | | | | | | |
| Time | 36 | 30 | 30 | 30 | 30 | 14 | 6 | 5 | Did not | Did not |
| required for | | | | | | | | | converge | converge |
| concentration | | | | | | | | | to 0 ppm | to 0 ppm |
| of hydrogen | | | | | | | | | | |
| sulfide to | | | | | | | | | | |
| reach 0 ppm | | | | | | | | | | |
| (min) | | | | | | | | | | |
| Stability | Stable | Stable | Stable | Stable | Stable | Stable | Stable | Stable | Unstable | Unstable |
| against | | | | | | | | | | |
| atmospheric | | | | | | | | | | |
| moisture | | | | | | | | | | |
| after water | | | | | | | | | | |
| immersion | | | | | | | | | | |
| Stability | Stable | Stable | Stable | Stable | Stable | Stable | Stable | Stable | Unstable | Unstable |
| against | | | | | | | | | | |
| water after | | | | | | | | | | |
| water | | | | | | | | | | |
| immersion | | | | | | | | | | |
| Stability | Stable | Stable | Stable | Stable | Stable | Stable | Stable | Stable | Unstable | Unstable |
| against | | | | | | | | | | |
| inorganic | | | | | | | | | | |
| acid after | | | | | | | | | | |
| water | | | | | | | | | | |
| immersion | | | | | | | | | | |

Referring to Exemplary Embodiments 1 to 8, when the sulfide-based solid electrolyte was subjected to water immersion at a weight ratio of sulfide-based solid electrolyte to water ranging from 1:3 to 1:100, the concentration of hydrogen sulfide (H₂S) gas generated decreased when the sulfide-based solid electrolyte was immersed in water.

In particular, when comparing the concentration of hydrogen sulfide gas according to different immersion ratios, in the case where the weight ratio of sulfide-based solid electrolyte to water was 1:100, the concentration of hydrogen sulfide gas converged to 0 ppm within about 5 minutes.

This demonstrates that, as the amount of water increased, Argyrodite(Li₆PS₅Cl) came into greater contact with water and reacted therewith, whereby the concentration of hydrogen sulfide gas promptly converged to 0 ppm.

Here, after introducing Argyrodite(Li₆PS₅Cl) into water and subjecting it to fine filtration, it was confirmed that more than 99.5% of the solid electrolyte was dissolved in water, leaving almost no residue.

At this time, the sulfide-based solid electrolyte treated by the pretreatment method through water immersion was converted into lithium compounds of Li₂SO₄, LiCl, Li₃PO₄, LiOH, or Li₂S.

Accordingly, the sulfide-based solid electrolyte treated by the pretreatment method through water immersion was converted into compounds stable against atmospheric moisture.

In addition, the sulfide-based solid electrolyte treated by the pretreatment method through water immersion was converted into compounds stable against water.

Furthermore, the sulfide-based solid electrolyte treated by the pretreatment method through water immersion was converted into compounds stable against inorganic acid.

In this case, the sulfide-based solid electrolyte treated by the pretreatment method through water immersion was converted into lithium compounds of Li₂SO₄, LiCl, Li₃PO₄, LiOH, or Li₂S, which are stable against atmospheric moisture, water, or inorganic acid.

Meanwhile, as in Comparative Embodiments 1 and 2, when the weight ratio of sulfide-based solid electrolyte to water was 1:1 to 1:2, it was confirmed, by the same method, whether the concentration of hydrogen sulfide gas converged to 0 ppm. As the amount of water was insufficient, a portion of Argyrodite(Li₆PS₅Cl) did not contact and react with water, and thus, even after 180 minutes, the concentration of hydrogen sulfide gas did not converge to 0 ppm.

In addition, the lithium secondary batteries comprising the sulfide-based solid electrolyte of Comparative Embodiments 1 and 2, after being subjected to water immersion, were unstable against atmospheric moisture, water, and inorganic acid.

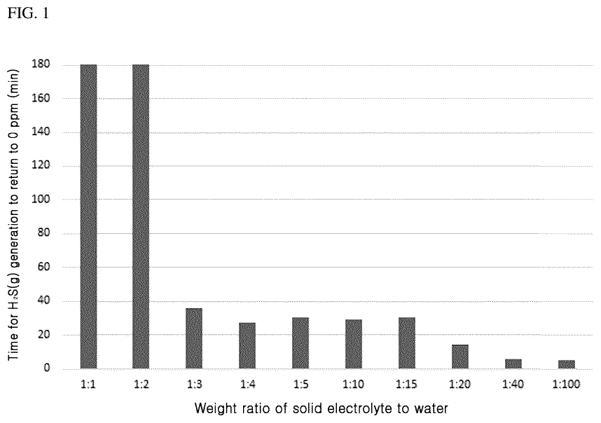

FIG. 1 is a graph comparing the time required for the concentration of hydrogen sulfide (H₂S) to return to 0 ppm when the sulfide-based solid electrolyte was immersed in water at different weight ratios, in the method for recycling a lithium secondary battery comprising a sulfide-based solid electrolyte through water immersion according to Exemplary Embodiments 1 to 8.

Referring to FIG. 1 and Table 1, when the sulfide-based solid electrolyte to water weight ratio of Exemplary Embodiment 1 was 1:3 during water immersion, the time required for the concentration of hydrogen sulfide (H₂S) to reach 0 ppm was confirmed to be about 36 minutes.

In Exemplary Embodiment 2, with a sulfide-based solid electrolyte to water weight ratio of 1:4 during water immersion, the time required for the concentration of hydrogen sulfide (H₂S) to reach 0 ppm was confirmed to be about 30 minutes.

In Exemplary Embodiment 3, with a sulfide-based solid electrolyte to water weight ratio of 1:5 during water immersion, the time required for the concentration of hydrogen sulfide (H₂S) to reach 0 ppm was confirmed to be about 30 minutes.

In Exemplary Embodiment 4, with a sulfide-based solid electrolyte to water weight ratio of 1:10 during water immersion, the time required for the concentration of hydrogen sulfide (H₂S) to reach 0 ppm was confirmed to be about 30 minutes.

In Exemplary Embodiment 5, with a sulfide-based solid electrolyte to water weight ratio of 1:15 during water immersion, the time required for the concentration of hydrogen sulfide (H₂S) to reach 0 ppm was confirmed to be about 30 minutes.

In Exemplary Embodiment 6, with a sulfide-based solid electrolyte to water weight ratio of 1:20 during water immersion, the time required for the concentration of hydrogen sulfide (H₂S) to reach 0 ppm was confirmed to be about 14 minutes.

In Exemplary Embodiment 7, with a sulfide-based solid electrolyte to water weight ratio of 1:40 during water immersion, the time required for the concentration of hydrogen sulfide (H₂S) to reach 0 ppm was confirmed to be about 6 minutes.

In Exemplary Embodiment 8, with a sulfide-based solid electrolyte to water weight ratio of 1:100 during water immersion, the time required for the concentration of hydrogen sulfide (H₂S) to reach 0 ppm was confirmed to be about 5 minutes.

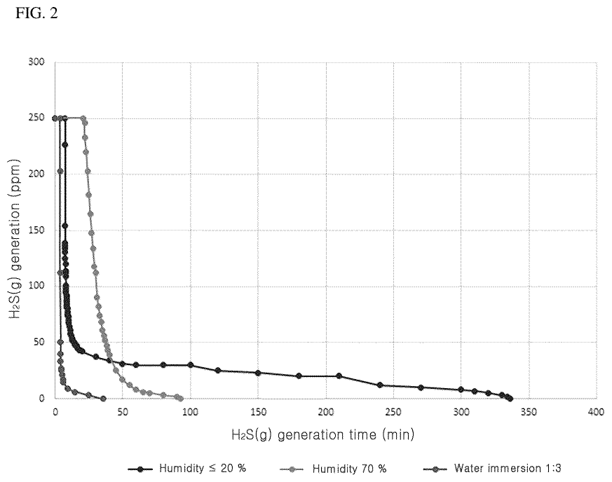

FIG. 2 is a graph comparing the concentration of hydrogen sulfide (H₂S) generated according to water immersion and atmospheric exposure of the sulfide-based solid electrolyte in the method for recycling a lithium secondary battery comprising a sulfide-based solid electrolyte through water immersion, according to Exemplary Embodiment 1.

Referring to FIG. 2, when the sulfide-based solid electrolyte to water weight ratio of Exemplary Embodiment 1 was 1:3 during water immersion, the time required for the concentration of hydrogen sulfide (H₂S) to reach 0 ppm was confirmed to be about 36 minutes.

In addition, the sulfide-based solid electrolyte treated by the pretreatment method through water immersion of Exemplary Embodiment 1 was exposed to atmospheric moisture, and stability was evaluated by measuring the time required for the concentration of hydrogen sulfide gas to reach 0 ppm using the hydrogen sulfide gas measurement method.

At this time, when the relative humidity was 20%, the time required for the concentration of hydrogen sulfide to reach 0 ppm was about 360 minutes, and when the relative humidity was 70%, the time required for the concentration of hydrogen sulfide to reach 0 ppm was about 90 minutes.

Accordingly, when exposed to the atmosphere, the higher the humidity, the shorter the time required for the concentration of hydrogen sulfide to reach 0 ppm.

Furthermore, it was confirmed that water immersion reduced the time for the concentration of hydrogen sulfide to reach 0 ppm more effectively than atmospheric exposure.

### <Exemplary Embodiments 9 to 12> Method for Recycling a Lithium Secondary Battery Comprising a Sulfide-Based Solid Electrolyte Through Water Immersion, in which Hydrogen Sulfide Converges to 0 ppm after a Certain Period of Time

First, cathode scraps comprising a sulfide-based solid electrolyte, obtained from waste batteries containing the sulfide-based solid electrolyte shown in Table 2 below, were placed into a desiccator connected to a hydrogen sulfide (H₂S) gas detector, while nitrogen gas was introduced at a rate of 10 L/min. The cathode scraps were subjected to water immersion at 25° C. for 3 hours at the weight ratios of cathode scrap to water shown in Table 2, and the concentration ofhydrogen sulfide gas was measured in ppm using the hydrogen sulfide gas detector.

In addition, by this water immersion, the generation of hydrogen sulfide (H₂S) gas was suppressed, and the sulfide-based solid electrolyte of the cathode scraps was converted into lithium compounds.

The lithium compounds were Li₂SO₄, LiCl, Li₃PO₄, LiOH, or Li₂S.

Thereafter, the time required for the concentration of hydrogen sulfide gas to reach 0 ppm was measured by the hydrogen sulfide gas measurement method.

In addition, the lithium secondary batteries comprising the water-immersed sulfide-based solid electrolyte were exposed to atmospheric moisture, and the stability was evaluated by measuring the time required for the concentration of hydrogen sulfide gas to reach 0 ppm using the hydrogen sulfide gas measurement method.

Further, the lithium secondary batteries comprising the water-immersed sulfide-based solid electrolyte were immersed in water, and stability was evaluated by measuring the time required for the concentration of hydrogen sulfide gas to reach 0 ppm using the hydrogen sulfide gas measurement method.

Furthermore, the lithium secondary batteries comprising the water-immersed sulfide-based solid electrolyte were immersed in nitric acid, and stability was evaluated by measuring the time required for the concentration of hydrogen sulfide gas to reach 0 ppm using the hydrogen sulfide gas measurement method.

TABLE 2

| | Exemplary | Exemplary | Exemplary | Exemplary |
|---|---|---|---|---|
| | Embodiment 9 | Embodiment 10 | Embodiment 11 | Embodiment 12 |
| Type of sulfide- | Argyrodite | LGPS | LPS | LPSCl |
| based solid | (Li₆PS₅Cl) | | | |
| electrolyte | | | | |
| Content of sulfide- | 10 | 10 | 10 | 10 |
| based solid | | | | |
| electrolyte in | | | | |
| cathode scrap (%) | | | | |
| Weight ratio of | 1:10 | 1:10 | 1:10 | 1:10 |
| cathode scrap to | | | | |
| water | | | | |
| Time required for | 5 | 5 | 5 | 5 |
| the concentration of | | | | |
| hydrogen sulfide to | | | | |
| reach 0 ppm after | | | | |
| water immersion (min) | | | | |
| Stability against | Stable | Stable | Stable | Stable |
| atmospheric | | | | |
| moisture after water | | | | |
| immersion | | | | |
| Stability against | Stable | Stable | Stable | Stable |
| water after water | | | | |
| immersion | | | | |
| Stability against | Stable | Stable | Stable | Stable |
| water after water | | | | |
| immersion | | | | |

Here, LGPS refers to Li₁₀GeP₂S₁₂(LGPS), LPS refers to Li₇P₃S₁₁(LPS), and LPSCl refers to Li_{9.54}Si_{1.74}P_{1.44}S_{11.7}Cl_{0.3}(LPSCl).

Exemplary Embodiment 9 was conducted under the assumption that, since the cathode scrap of an all-solid-state battery comprises a mixture of a cathode active material and Argyrodite(Li₆PS₅Cl), the amount of Argyrodite(Li₆PS₅Cl) in the cathode scrap is 10 wt %. Under this assumption, an experiment was carried out to verify whether the same results would be obtained when immersing the cathode scrap in water under the same weight ratio conditions as based on Argyrodite (Li₆PS₅Cl) alone.

Specifically, the weight ratio of cathode scrap to water was set at 1:10, and the time required for the concentration of hydrogen sulfide to reach 0 ppm was measured. The experimental results confirmed that the time required for the concentration of hydrogen sulfide to reach 0 ppm was about 5 minutes. This result was consistent with that obtained under the condition of an Argyrodite(Li₆PS₅Cl)-to-water weight ratio of 1:100, thereby confirming the validity of the assumption.

In addition, for Exemplary Embodiments 10 to 12, the weight ratio of cathode scrap to water was set at 1:10, and the time required for the concentration of hydrogen sulfide to reach 0 ppm was measured. The experimental results confirmed that the time required for the concentration of hydrogen sulfide to reach 0 ppm was about 5 minutes.

At this time, the lithium secondary batteries comprising the sulfide-based solid electrolyte treated by the pretreatment method through water immersion according to Exemplary Embodiments 9 to 12 were stable against atmospheric moisture after water immersion.

Furthermore, the lithium secondary batteries comprising the sulfide-based solid electrolyte treated by the pretreatment method through water immersion according to Exemplary Embodiments 9 to 12 were stable against water after water immersion.

In addition, the lithium secondary batteries comprising the sulfide-based solid electrolyte treated by the pretreatment method through water immersion according to Exemplary Embodiments 9 to 12 were stable against inorganic acid after water immersion.

In the above, exemplary embodiments of the method for recycling a lithium secondary battery comprising a sulfide-based solid electrolyte through water immersion according to the present disclosure have been described. Moreover, it will be appreciated that various modifications to these exemplary embodiments are possible without departing from the scope of the present disclosure.

The scope of the present disclosure should therefore not be limited to those exemplary embodiments described above, but should be defined by the following claims and their equivalents.

In other words, the foregoing exemplary embodiments are to be understood as illustrative rather than restrictive in all respects, and the scope of the present disclosure is indicated by the following claims rather than the detailed description. All modifications or variations derived from the meaning, scope, and equivalent concepts of the claims should be interpreted as being included within the scope of the present disclosure.

What is claimed is:

1. A method for recycling a lithium secondary battery comprising a sulfide-based solid electrolyte through water immersion, the method comprising:
subjecting the sulfide-based solid electrolyte of a waste battery comprising a sulfide-based solid electrolyte to water immersion to suppress generation of hydrogen sulfide (H₂S) gas; and
converting the sulfide-based solid electrolyte into a lithium compound.

2. The method of claim 1,
wherein the sulfide-based solid electrolyte is subjected to water immersion after being separated from the waste battery, or is subjected to water immersion in a state of being not separated from the waste battery.

3. The method of claim 1,
wherein the sulfide-based solid electrolyte comprises at least one selected from the group consisting of Li₁₀GeP₂S₁₂(LGPS), Li₇P₃S₁₁(LPS), Li_{9.54}Si_{1.74}P_{1.44}S_{11.7}Cl_{0.3}(LPSCl), and Li₆PS₅X(X=Cl, Br, or I)(Argyrodite).

4. The method of claim 1,
wherein the water immersion is performed at a temperature ranging from 10° C. to 100° C.,
for a time period ranging from 2 minutes to 6 hours, and
wherein air or nitrogen gas is introduced during the water immersion.

5. The method of claim 4,
wherein the air or nitrogen gas is introduced during the water immersion at a flow rate ranging from 0.5 to 50 L/min.

6. The method of claim 1,
wherein, when the sulfide-based solid electrolyte is subjected to water immersion, in a case where a content ratio of the sulfide-based solid electrolyte to water is in a weight ratio ranging from 1:3 to 1:100,
wherein an amount of hydrogen sulfide (H₂S) gas generation measured by a hydrogen sulfide (H₂S) gas detector ranges from 0 to 250 ppm, and
wherein, after the hydrogen sulfide (H₂S) gas has generated, a time required for the amount of hydrogen sulfide (H₂S) gas generation to return to 0 ppm ranges from 2 minutes to 1 hour.

7. The method of claim 1,
wherein the lithium compound is at least one selected from the group consisting of Li₂SO₄, LiCl, Li₃PO₄, LiOH, and Li₂S.

8. The method of claim 1,
wherein, after being subjected to water immersion, the lithium secondary battery comprising a sulfide-based solid electrolyte is stable against atmospheric moisture.

9. The method of claim 1,
wherein, after being subjected to water immersion, the lithium secondary battery comprising a sulfide-based solid electrolyte is stable against water.

10. The method of claim 1,
wherein, after being subjected to water immersion, the lithium secondary battery comprising a sulfide-based solid electrolyte is stable against an inorganic acid selected from the group consisting of hydrochloric acid (HCl), nitric acid (HNO₃), and sulfuric acid (H₂SO₄).
